(19) United States
(12) Patent Application Publication
(10) Pub. No.: US 2010/0121692 A1
(43) Pub. Date: May 13, 2010

(54) ADVERTISEMENT SCREEN ON PAYMENT CARD

(76) Inventor: Mustafa Cemal TOP, San Mateo, CA (US)

Correspondence Address: Visa USA c/o Duane Morris LLP;Attn: James Sze, Esq., 101 West Broadway, Suite 900, San Diego, CA, 92101, US

(21) Appl. No.: 12/268,528

(22) Filed: Nov. 11, 2008

(51) Int. Cl. G06Q 30/00; G06K 19/06

(52) U.S. Cl. 705/14.4; 235/493

(57) ABSTRACT

A financial transaction card having a card with a front face and a back face, a financial payment device on or in the card, an advertising screen on one of the front face and the back face, and at least one activating arrangement connected to the advertising screen, configured to activate and deactivate the screen.

### FIELD OF THE INVENTION

Aspects of financial transaction cards are described.

### BACKGROUND INFORMATION

The need for conducting accurate transactions between parties, such as between a customer using a credit card and a merchant, becomes paramount as the financial transaction card industry strives for increasingly cost efficient, safe and secure apparatus and methods to complete these transactions. Conventional technologies used by financial institutions and consumers alike, while providing the ability to conduct financial transactions, are not adaptable to make the consumer aware of new offers for service.

Conventional cards, such as credit cards, bank cards, debit cards and other financial transaction cards are configured with a plastic body that has a unique identification number imprinted on the card. The cards also have a magnetic strip that allows for a magnetic verification of the authenticity of the card to the financial institution issuing the card. Cards having additional functionality are desired.

### SUMMARY OF THE INVENTION

In one configuration, a financial transaction card is presented. The financial transaction card has a front face and a back face. A financial payment device is positioned on or in the card. An advertising assembly is also positioned on one of the front face and the back face. At least one activating arrangement is connected to the advertising assembly configured to activate and deactivate the advertising assembly.

In another aspect, a method of advertising is presented. The method comprises: conducting a financial transaction between the merchant and a card holder including use of a payment card, communicating between a merchant communication device and the payment card to transfer information between the merchant communication device and the payment card, and conducting an advertisement on the payment card from the information obtained from the merchant communication device.

### BRIEF DESCRIPTION OF THE DRAWINGS

FIG. 1 is a front view of a payment card as described in the detailed description.

FIG. 2 is a back view of the payment card of FIG. 1.

FIG. 3 is a flow chart of a method of advertising.

### DETAILED DESCRIPTION

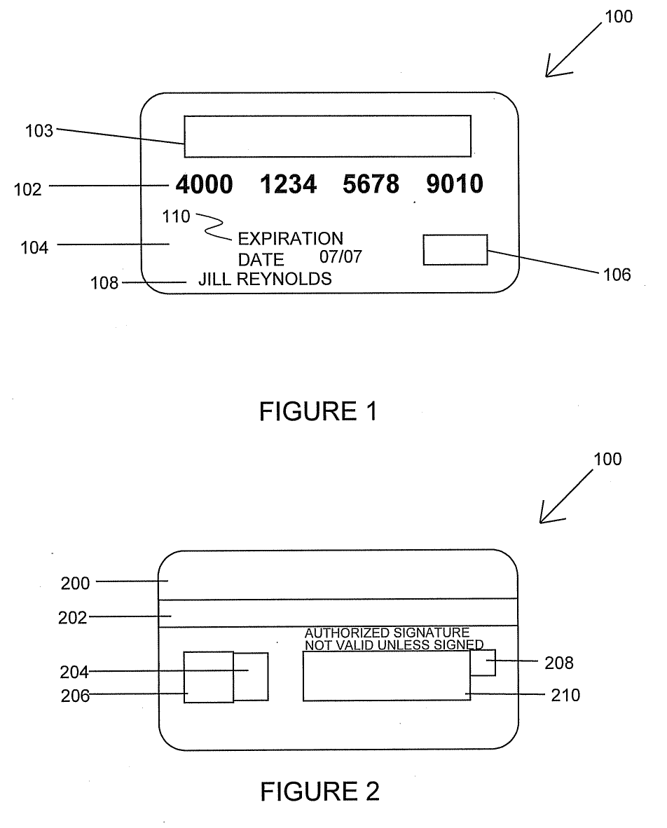

Referring to FIG. 1, a financial transaction card 100 is presented. In the illustrated configuration, the financial transaction card 100 has a rectangular shape. Although illustrated as a rectangular shape, other shapes may be used. The financial transaction card 100 is a plastic bodied card however other materials may be used. The financial transaction card 100 may be configured in a conventional shape such that various automated payment machines may accept the financial transaction card 100.

A serial number 102 is located on a first (e.g., front) face 104 of the financial transaction card 100. The serial number 102 is unique to the individual card and allows an issuing organization to track financial purchases and transactions to the financial transaction card 100. The serial number 102, as it is unique, allows an issuing organization to identify potential fraud occurring through the unauthorized use of the financial transaction card 100. A database of serial numbers for financial transaction cards that have been stolen or compromised may be maintained by the issuing organization thereby preventing further fraudulent transactions from occurring with a compromised financial transaction card 100. The front face 104 of the financial transaction card 100 may be a smooth surface with raised numbers. Tactile features may be placed on the front face 104 of the financial transaction card 100 to allow a user to quickly identify the front face 104 from the back face 200 of the financial transaction card 100. Other tactile features, such as Braille encoding may be included on the front face 104 of the financial transaction card 100 thereby allowing individuals who have visual difficulty to nonetheless use the financial transaction card 100.

A holograph 106 may also be located on the front face 104 of the financial transaction card 100. The holograph 106 provides an additional protection against fraud by allowing a merchant to quickly identify if a financial transaction card 100 is a validly authorized card. An authorization name 108 is also located on the front face 104 of the financial transaction card 100. Additionally, an expiration date 110 is located on the front face 104 of the financial transaction card 100. The expiration date 110 quickly indicates to a merchant the expiration date of the financial transaction card 100 such that purchases after the expiration date 110 cannot be performed.

In some embodiments, an advertising assembly 103 is located on the front face 104 of the financial transaction card 100. In other embodiments, the advertising assembly 103 is located on the back face 200. The advertising assembly 103, in the illustrated configuration, is an electronic paper screen with electronic ink, such as an electrophoretic display, an electro-wetting display, a bistable LCD, a cholesteric LCD, or the like. The advertising assembly 103 may also be a bistable screen. The advertising assembly 103 is connected to both a battery 204 and an activating arrangement or circuit 206, described below. In the illustrated embodiment, the advertising assembly 103 and the below-described activating arrangement 206 are powered by a battery 204. In another embodiment, financial transaction card 100 may include electrical contacts for connecting to a voltage supply terminal and a ground terminal of a merchant payment reader or terminal configured to provide power to the card 100 from an external source. In another embodiment, financial transaction card 100 may include an antenna to receive power from an external electromagnetic field of a merchant payment reader or terminal configured to provide power to the card 100. In some embodiments, the advertising assembly 103 may not draw any power in between state changes. In other embodiments, the advertising assembly 103 may draw power for a relatively short time just before or just after a state change, and have a period between state changes when the advertising assembly 103 does not draw power. For example, the advertising assembly 103 may draw power only during the transitions between displaying the advertisement and not displaying the advertisement, and draw no power during at least a portion of the period when the advertisement is displayed. Similarly, the advertising assembly 103 may draw no power during at least a portion of the period when no advertisement is displayed.

The advertising assembly 103 allows for either a predefined advertisement to be displayed upon the advertising assembly 103 or, through use of the activating arrangement 206, the advertising assembly 103 may display different advertisements that are received from a source exterior to the card systems. The advertising assembly 103 can display alphanumeric data or may provide a picture or logo. The advertising assembly 103 also may include a speaker or a combination of a speaker and an advertising screen. An override function/button may also be placed upon the card 100 such that advertising is halted upon the selection by the user. The advertising assembly 103 may provide a static display in the case of a picture or text, or, in alternative aspects, provide for motion in video format.

In some embodiments, the advertising assembly 103 requires no front or back light, thereby allowing individuals to view the advertising assembly data with little power consumption. The advertising assembly 103 is also viewable under a wide range of circumstances such as from varying angles. The advertising assembly 103 is also configured such that ultra low power is used to develop and maintain an image on the financial transaction card 100. in some embodiments, the advertising assembly 103 is also flexible and can be bent without harm to the advertising assembly 103. Under differing electronic/magnetic fields, materials placed in the fluid environment will either gather at the surface or dissipate from the surface thereby creating images for the card user to view. By alternating the electronic/magnetic fields, different messages or video playback may be accomplished. Alternative embodiments may include a front lit screen, for example.

Referring to FIG. 2, a back face 200 of the financial transaction card 100 is presented. The back face 200 of the financial transaction card 100 may be essentially smooth, unlike the front face 104 that has tactile features placed upon it. The back face 200 has a financial payment device 202 that will interact with financial transaction systems used in commerce. Examples of different types of financial payment device 202 are a magnetic stripe, a contact electronic transfer system, or a contactless data transfer system. For a contactless data transfer system, randomized authorization codes may be used to prevent fraud from occurring. In some embodiments, a radio frequency identification system is used as the contactless data transfer system. Depending on the type of financial payment device 202, the device may be on either the front or rear surface of the card (e.g., if the device is a magnetic stripe) or embedded in the card (e.g., if the device is a chip or circuit).

In the illustrated configuration, the financial payment device 202 is a magnetic stripe that does not require charging. A battery 204 is embedded in the financial transaction card 100 to provide power to an activating arrangement 206 and an advertising assembly 103. In the illustrated embodiment, the battery 204 is a rechargeable unit, however, the battery presented may be a one-time only charged unit. The battery 204 itself may also be incorporated into the body of the card 100 so that a user of the financial transaction card 100 does not see the battery 204The thin-film battery 204 is preferably a flexible unit that will withstand shock and vibration such that connection is not lost to other components on the financial transaction card 100. In alternative configurations, the thin-film battery 204 may be a rechargeable unit and may be charged by induction coupling. The thin-film battery 204 may also be configured to be heat resistant The thin-film battery 204 may also be waterproof and shockproof.

An activating arrangement 206 is illustrated on the back face 200 of the financial transaction card 100. The activating arrangement 206, in the illustrated configuration, may include a computer or application specific integrated circuit chip that can receive wired or wireless transmission from an outside source, such as from a merchant communication device, through a built-in communication arrangement or circuit. The activating arrangement 206 is connected to the advertising assembly 103 located on the front face 104 of the financial transaction card 100. The activating arrangement 206 allows the financial transaction card 100 to accept data from a merchant communication device (e.g., reader or terminal), decode the data, and outputting the data such that the data is displayed upon the advertising assembly 103 of the financial transaction card 100. In some embodiments, the activating arrangement 206 also provides a storage buffer (e.g., a plurality of memory cells) for rate matching. The storage buffer may be advantageous for decoding and displaying video or sequences of multiple images, for example.

The information transmitted to the financial transaction card 100 may also be an open source or standard format data transfer, thereby minimizing decoding requirements of the card 100. In an alternative configuration, the activating arrangement 206 is connected to the financial payment device 202. As an additional security check, the activating arrangement 206 may activate the financial payment device 202, thereby authorizing a financial transaction. A security code 208 is also located on the back face 200 of the financial transaction card 100. A bearer of the financial transaction card 100 is also provided with an authorized signature block 210 thereby allowing a merchant to check a signature of the cardholder. Either the front face 104 or the back face 200 may be configured with a photo identification of the bearer of the card. Artwork/Logo work may also be located on various portions of the card 100. The front face 104 and the back face 200 of the financial transaction card 100 may also be configured with contact information and payment information for the issuer of the card 100.

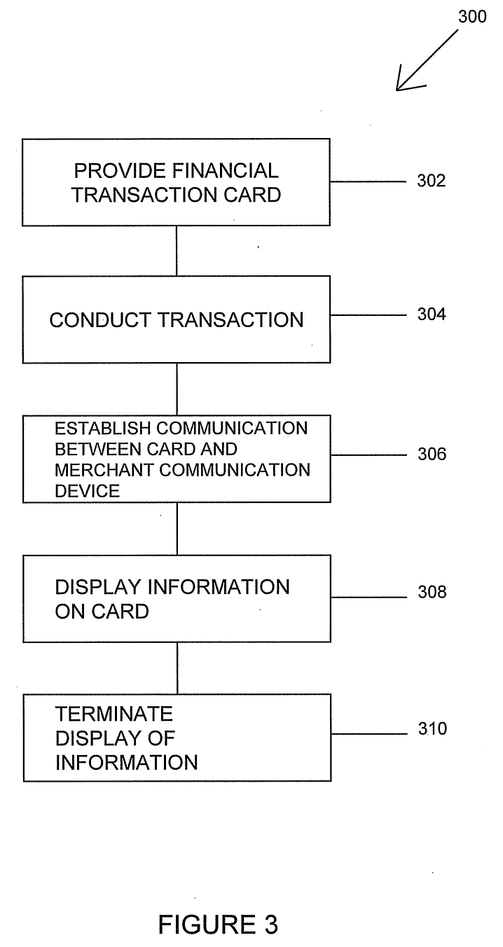

Referring to FIG. 3, a method 300 of advertising is presented. In the method 300, a financial transaction card is provided to a merchant such that a financial transaction can be completed 302. Next, a financial transaction is conducted between a merchant and the cardholder 304. This can be, for example, a purchase of an item from the vendor/merchant. A communication is established between a merchant communication device and the financial transaction card such that information is transferred between the merchant communication device and the financial transaction card 306. In the illustrated configuration provided, the merchant communication device may be a transmitter that sends data over a wireless network to a financial transaction card it is capable of receiving information placed upon the wireless network. The data may be encoded or may not be encoded in different configurations. The financial transaction card then takes the information from the merchant communication device and displays the information on an advertising assembly located on the financial transaction card 308. The advertisement may be terminated 310 based upon either elapse of a preset time or a signal received from the merchant communication device that terminates the advertisement placed on the financial transaction card 100.

In the foregoing specification, the configurations have been described with reference to specific configurations thereof. It will, however, be evident that various modifications and changes may be made thereunto without departing from the broader spirit and scope of the configurations as set forth in the appended claims. The specification and drawings are accordingly to be regarded in an illustrative rather than in a restrictive sense.

What is claimed is:

1. A financial transaction card, comprising:
a card with a front face and a back face;
a financial payment device on or in the card;
an advertising assembly on one of the front face and the back face; and
at least one activating arrangement connected to the advertising assembly, configured to activate and deactivate the advertising assembly.

2. The financial transaction card according to claim 1, wherein the advertising assembly includes a bistable screen that is configured to draw power only when the screen changes between a first state and a second state.

3. The financial transaction card according to claim 1, wherein the advertising assembly Includes a screen that is configured to draw power to display an advertisement, and is configured to not draw power during at least a portion of a period when the advertisement is being displayed.

4. The financial transaction card according to claim 1, wherein the at least one activating arrangement comprises a computer chip.

5. The financial transaction card according to claim 1, wherein the financial payment device has electrical contacts.

6. The financial transaction card according to claim 5, wherein the contact driven transaction arrangement is a magnetic stripe.

7. The financial transaction card according to claim 1, wherein the financial payment device is a contactless device.

8. The financial transaction card according to claim 1, further comprising: a battery attached to the at least one activating arrangement.

9. The financial transaction card according to claim 8, wherein the battery is a rechargeable battery.

10. The financial transaction card according to claim 1, wherein:
the advertising assembly includes a screen coupled to the at least one activating arrangement,
the activating arrangement is configured to activate and deactivate the screen, and
the advertising assembly further comprises a communication device configured to interface with the screen to transfer information from an outside source to the screen.

11. A method of advertising, comprising:
conducting a financial transaction between a merchant and a card holder, including use of a financial transaction card at a merchant point of sale;
communicating between a merchant communication device at the merchant point of sale and the financial transaction card to transfer information between the merchant communication device and the financial transaction card; and
conducting an advertisement on the financial transaction card from the information obtained from the merchant communication device.

12. The method according to claim 11, wherein the conducting of the advertisement includes displaying information on at least one of a front face and a back face of the card.

13. The method according to claim 11, wherein the advertisement is displayed on a display screen of the card.

14. The method according to claim 13, wherein the screen includes a bistable screen that is configured to draw power only when the screen changes between a first state and a second state.

15. The method according to claim 13, wherein the display screen is configured to draw power during a state change to display the advertisement, and is configured to not draw power during at least a portion of a period when the advertisement is being displayed.

16. The method according to claim 11, further comprising:
terminating displaying of the advertisement on the financial transaction card after an amount of elapsed time.

17. The method according to claim 16, wherein the amount of time is a preset time.

18. The method according to claim 11, wherein the advertisement is a static picture.

19. The method according to claim 11, wherein the advertisement is a video clip.

20. The method according to claim 11, wherein the advertisement is a sound clip.

21. The financial transaction card according to claim 1, wherein the advertising assembly includes a speaker configured to play a sound.

22. The financial transaction card according to claim 1, wherein the advertising assembly comprises a speaker and a bistable screen that is configured to draw power only when the screen changes between a first state and a second state.

23. The financial transaction card according to claim 1, wherein the advertising assembly comprises a speaker and a screen that is configured to not draw power during at least a portion of a period when the advertisement is not displayed.

24. A computer-readable medium, encoded with data and instructions, that when executed by a computing-device causes the computing device to:
conduct a financial transaction between the merchant and a card holder;
communicate between a merchant communication arrangement and the financial transaction card to transfer information between the merchant communication arrangement and the financial transaction card; and
conduct an advertisement on the financial transaction card from the information obtained from the merchant communication arrangement.

25. The computer-readable medium, according to claim 24, wherein the conducting of the advertisement is on at least one of a front face and a back face of the card.

26. The computer-readable medium, according to claim 24, wherein the advertisement is displayed on a display screen for the card.

27. The financial transaction card according to claim 1, wherein the advertising assembly is a bistable screen that is configured to not draw power during at least a portion of a period between a first change of state and a second change of state.
